(19) United States
(12) Patent Application Publication
(10) Pub. No.: US 2025/0237283 A1
(43) Pub. Date: Jul. 24, 2025

(54) Shock Absorber Structure

(71) Applicant: VIETTEL GROUP, Ha Noi City (VN)

(72) Inventors: XUAN SON NGUYEN, Ha Noi City (VN); VAN THIEN NGUYEN, Ha Noi City (VN); ANH TUAN CAO, Ha Noi City (VN); VAN TUNG PHAM, Ha Noi City (VN); HUY PHONG PHAM, Bac Ninh City (VN); MANH CUONG NGUYEN, Ha Noi City (VN); THO TUAN LE, Thuong Xuan District (VN)

(73) Assignee: VIETTEL GROUP, Ha Noi City (VN)

(21) Appl. No.: 18/952,935

(22) Filed: Nov. 19, 2024

(30) Foreign Application Priority Data
Jan. 23, 2024 (VN) 1-2024-00547

(51) Int. Cl. F16F 7/12; E01D 19/04

(52) U.S. Cl. CPC F16F 7/125; E01D 19/042; F16F 2230/0064; F16F 2232/08

(57) ABSTRACT

A shock absorber structure to absorb vibrations in multiple directions. The shock absorber structure includes a horizontal shock absorber assembly to absorb horizontal vibrations, a vertical shock absorber assembly to absorb vertical vibrations, and a horizontal shock absorber assembly linked to the vertical shock absorber assembly through a cam. Main body assembly to connect the horizontal shock absorber assembly and vertical shock absorber assembly. The horizontal shock absorber assembly includes the bridge deck pillar, spring shaft, sliding shaft, and the first elastic element. The longitudinal shock absorber assembly includes traction ear, first bushing, second bushing, centering shaft, second elastic element. The vertical shock absorber assembly is arranged perpendicular to the horizontal shock absorber assembly.

### FIELD OF INVENTION

The invention relates to the field of mechanical components. Specifically, the invention pertains to a shock absorber structure, more particularly a shock absorber structure utilizing two spring assemblies to reduce overload vibrations in equipment.

### DESCRIPTION OF RELATED ART

Shock absorbers serve the purpose of absorbing, reducing, or dampening vibrations in machinery during operation. They are essential in preventing excessive vibrations that could adversely affect the machine's functionality and lifespan. Thus, shock absorbers enhance the smoothness and stability of the machinery in use.

Patent CN110381685A discloses a shock absorber structure for anti-vibration cabinets. This structure includes springs arranged horizontally to absorb lateral forces and springs arranged vertically to absorb vertical forces. However, this structure is only suitable for devices with two orthogonal force-bearing planes and is not effective for reducing vibrations in equipment with large loads.

Patent CN111853453A discloses a shock absorber structure for cameras. This structure includes four springs arranged in the camera mounting plane to absorb horizontal forces and four springs arranged at angles to absorb non-horizontal forces. This design is suitable for suspended structures primarily bearing upward forces, not for supporting heavy loads or absorbing primarily downward forces.

Patent JP2005240998A discloses an anti-seismic structure with two shock absorber assemblies to absorb vibrations in different directions, connected by a spherical joint. This structure can bear large loads but is more effective for vibrations from below rather than above, making it more suitable for buildings than machinery. The shock absorber assemblies tend to separate during operation, requiring a large installation space.

Therefore, there is a need for a shock absorber structure that capitalizes on the advantages and overcomes the disadvantages of known devices.

### SUMMARY OF THE INVENTION

The invention aims to propose a shock absorber structure capable of absorbing vibrations in at least two directions. Another objective is to propose a highly stable shock absorber suitable for equipment with heavy loads. Additionally, the invention aims to propose a modular shock absorber structure that is easily adaptable to various machines and working environments and is easy to maintain, replace, and repair.

To achieve one or more of the above objectives, the invention proposes a shock absorber structure comprising:

At least one horizontal shock absorber assembly to absorb horizontal vibrations, including a spherical post to receive the load causing the vibration, a spring shaft connected to the spherical post and capable of rotating with it, and a slide shaft that can rotate inside the slide tube. The first elastic element is arranged around the spring shaft, so its rotation causes deformation of the first elastic element. The slide tube is designed to slide inside the main body assembly, with a coupling to the transition cam.

At least one vertical shock absorber assembly to absorb vertical vibrations, including a pull ear connected to the transition cam, a first bushing with one end fixed to the pull ear and the other end interlocking with a centering shaft. The centering shaft, located inside the first bushing, interlocks with its inner surface, allowing the first bushing to pull the centering shaft in one direction and slide along its surface in the opposite direction. The centering shaft's other end is fixed inside a second bushing, which is positioned opposite the first bushing. The second elastic element is arranged around both bushings to deform when either bushing moves. The vertical shock absorber assembly body is tubular, surrounding its components and connecting perpendicularly to the horizontal shock absorber assembly.

The horizontal and vertical shock absorber assemblies are connected via a transition cam, which can rotate around a cam axis perpendicular to both assemblies.

At least one main body assembly to connect the horizontal and vertical shock absorber assemblies, designed as a hollow cylinder housing the slide tube and the transition cam coupling.

In addition, the shock absorber mechanism according to the present invention may also include a number of other markings separately, separately or in combination, such as:

It is preferable that the horizontal shock absorber assembly also includes a support post connecting the bridge deck post with the suspension shaft, a cap arranged around and covering the first elastic element, an adjusting nut covering the connection between the support post and The spring shaft and adjusting nut are located above the above cover so that the distance between the parts can be adjusted appropriately when there is a change in the stiffness of the elastic element.

It is better that the bridge deck pier includes a top shaped like a spherical cap and a locking cover to connect the deck pier with the support post. This structure allows the replacement of bridge deck pillars with different shapes to flexibly fit the connection parts of many types of equipment.

In addition, during the working process, the spherical cap surface of the bridge deck pier is also regularly abraded, so this structure allows the bridge deck pier to be easily replaced while still retaining the other parts.

It is better that the transfer cam connects with the horizontal shock absorber assembly and vertical shock absorber assembly through a ball joint because the connection point both moves linearly with the shock absorber assembly and rotates with the transfer cam.

The main body assembly preferably also includes a second flange arranged at the bottom of the main body assembly to connect with the base, a travel stopper arranged at the bottom of the void of the main body assembly to limit the position of movement of the shaft slide inside the main body assembly. Even better, the main body assembly also includes stiffening ribs to ensure structural stability.

It is preferable that the first elastic element and the second elastic element be springs for ease of installation placement and replacement.

Better yet, the horizontal shock absorber assembly also includes a telescopic damper element located inside the shock shaft to increase the effectiveness of vibration suppression.

Better yet, the vertical shock absorber assembly also includes a telescopic damping element arranged inside the centering shaft to increase vibration suppression efficiency.

### BRIEF DESCRIPTION OF DRAWINGS

The invention will now be described in detail according to preferred embodiments with reference to accompanying drawings. However, it should be understood that these embodiments are provided as examples to facilitate a better understanding of the invention and its advantages, without limiting the scope of the invention to these specific embodiments.

FIG. 1: Partial cross-sectional view of the shock absorber structure according to the invention.

FIG. 1A: Partial cross-sectional view of the shock absorber structure at cam axis.

FIG. 2: Isometric view of the main body assembly of the shock absorber structure according to the invention.

FIG. 3: Cross-sectional view of the horizontal shock absorber assembly.

FIG. 4: Isometric view of the vertical shock absorber assembly.

FIG. 5: Cross-sectional view of the vertical shock absorber assembly.

FIG. 6: Perspective view illustrating one arrangement of the shock absorber structure.

FIG. 7: Exploded perspective view illustrating the components of one arrangement of the shock absorber structure.

### COMPONENT LIST

A: Spherical post
B: Main body assembly
C: Vertical shock absorber assembly
D: Horizontal shock absorber assembly
E: Base
G: Shock absorber structure
M: Frame
1: First flange
2: Spherical top
3: Lock cover
4: Retaining ring
5: Support post
6: Spring shaft
7: Adjustment nut
8: Slide tube
9, 12, 24, 26: Washers
10: First elastic element
11: Cover cap
13: Second flange
14: Pull ear
15: Sliding bearing
16: Travel stopper
17: Second elastic element
18: Second bushing
19: Centering shaft
20: Cam axis
21: First bushing
22: Vertical shock absorber body
23: Vertical shock absorber cap
25: Transition cam

### DETAILED DESCRIPTION

Below, the invention will be described in detail according to the preferred implementation options based on the accompanying drawings. However, it should be understood that these options are only described for the purpose of serving as an example to help better understand the nature and advantages of the invention, without limiting the scope of the invention to the embodiments herein described. The concepts of horizontal, vertical, vertical, horizontal, upper, lower, etc. need to be determined based on the state of the damping mechanism when placed on the ground. The concepts of left and right are determined based on drawings.

The shock absorber structure G according to the present invention includes: at least one horizontal shock absorber assembly D to absorb vibrations in the horizontal direction, at least one vertical shock absorber assembly C to absorb vibrations in the vertical direction, in which the horizontal shock absorber assembly D is linked to the vertical shock absorber assembly C through transfer cam 25, at least one main body assembly B to link horizontal shock absorber assembly D and vertical shock absorber assembly C.

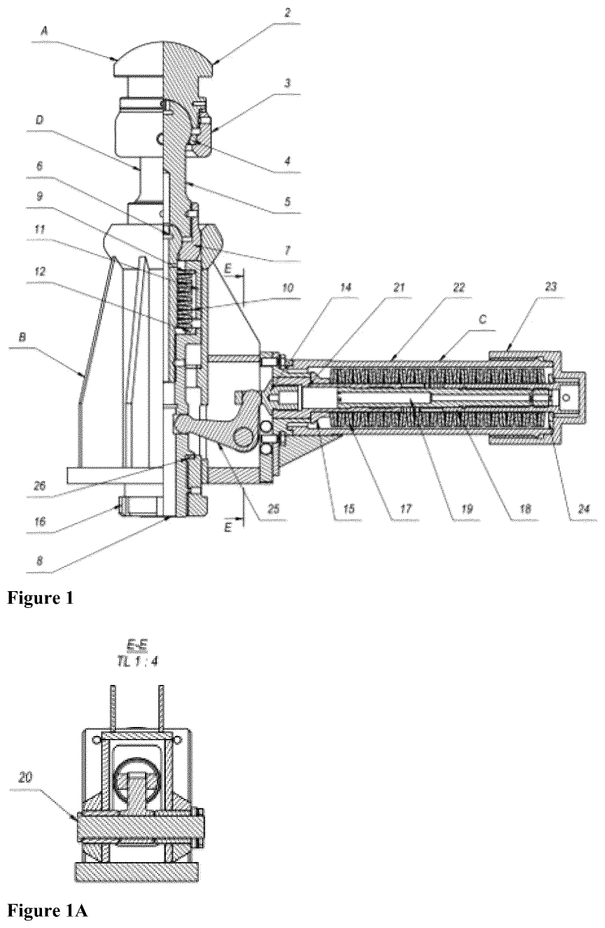

According to a preferred plan for implementing the invention shown in FIGS. 1 and 3, the horizontal shock absorber assembly D is structured to include deck pillar A to receive the load causing vibrations, and shock shaft 6 moves up, down to deform the first elastic element 10, sliding shaft 8 to transmit the load component causing longitudinal vibration to the longitudinal shock absorber assembly C through the transfer cam 25.

Suspension shaft 6 connects with bridge deck pillar A in a way that can be rotated along with bridge deck pillar A. According to a simple plan, the bridge deck A can be made integral with the spring shaft 6 and on the body of the spring shaft 6 there is a protrusion to press on the first elastic element 10. However, this plan has disadvantages. The point is that it is difficult to adjust when it is necessary to change the stiffness of the elastic element and when the bridge deck A is worn, both the bridge deck A and shock shaft 6 must be replaced. Therefore, it is better to have the spring shaft 6 linked to Bridge deck pillar A through support pillar 5.

As shown in FIG. 3, the hood 11 is arranged around and over the element

The first elastic 10, the adjusting nut 7 covers the connection between the support column 5 and the swing shaft 6, the adjusting nut 7 is located above the cover 11. The cover 11 will press on and deform the element. first elastic element 10. When it is necessary to change the initial stiffness of the elastic element, it is possible to change the cover and/or adjust the distance between the sliding shaft 8 and the adjusting nut 7. The adjustable nut 7 can be mounted so that it can rotate with the support column 5 and move with the swing shaft 6. According to a preferred embodiment shown in FIG. 3, the adjusting nut 7 is fixed to the support post 5 with a pin and the end of the swing shaft 6 is made The spherical cap structure protrudes from the cylindrical body to match the adjusting nut hole 7. The support pier 5 and the swing shaft 6 can be connected in many ways, axial screws can be used as shown in FIG. 3 to connect. Simplify fabrication or use another joint, for example a joint with redundancy. Such alternative embodiments may be implemented by one of ordinary skill in the art and are within the scope of the invention.

The first elastic element 10 can be chosen from among many known types of machine parts, such as springs, torsion bars, etc., provided that it has suitable stiffness and dimensions. According to a preferred embodiment of the invention shown in FIGS. 1 and 3, the second elastic element 10 is the spring arranged coaxially with the spring shaft 6 and surrounding the spring shaft 6. Obviously The first elastic element 10 can be arranged in another way, for example by using multiple springs arranged around the circumference of the cross-section of the swing shaft 6. These arrangements are also within the scope of the invention. In the embodiment shown in FIGS. 1 and 3, it is preferable to further include a washer 9 arranged above the first elastic element 10 and a washer 12 arranged below the first elastic element 10. No. The amount of gasket can also be increased for convenient adjustment during use.

To facilitate replacement, deck pier A includes the top part 2, which is made of a spherical shape and a locking cover 3 to connect deck pier A with support pier 5. According to the plan shown in FIG. 1, the pier Support 5 has a spherical top structure that protrudes from the cylindrical body.

To increase friction between lock cover 3 and support pillar 5, additional stop ring 4 can be arranged between lock cover 3 and support pillar 5.

Swing shaft 6 is linked to slide shaft 8 in such a way that it rotates inside the slide shaft 8 absorb horizontal vibrations and must move along the slide axis 8 to absorb vertical vibrations.

The outer wall of the sliding shaft 6 is externally threaded and the inner wall of the sliding shaft 8 is internally threaded These two details fit together. Therefore, when there is an impact of horizontal load, the spring shaft 6 will rotates inside the sliding shaft 8 and when there is an impact of vertical load, the sliding shaft 6 will lock with the sliding shaft 8 and push/pull the sliding shaft 8 to move.

The sliding shaft 8 is structured so that it can slide inside the main body assembly B. On the sliding shaft body 8 there is a part connected to the transfer cam 25. According to a preferred embodiment of the invention shown in FIG. 1 and FIG. 3, the sliding shaft 8 has an enlarged end to support the first elastic element 10, the basic body is cylindrical in shape and the tail part is shaped with a diameter larger than the hole inside the travel stopper 16. Stopper stroke 16 is arranged at the bottom of the hollow space of the main body assembly B to limit the movement position of the sliding shaft 8 inside the assembly main body B. At the top of the hole inside the travel stopper 16, the washer 26 is arranged to reduce wear of the travel stopper 16. The number of items of washer 26 can also be increased for convenient adjustment during use. On the body of slider shaft 8, there is a part linked to shift cam 25 to pull shift cam 25 to rotate when slider shaft 8 moves. According to a preferred embodiment of the invention shown in FIGS. 1 and 3, this connecting part is a ball joint.

Other connection mechanisms can also be used, for example hinge joints. These layout options are also within the scope of the invention.

According to another embodiment not shown in the drawings, the horizontal shock absorber assembly D also includes a telescopic damping element arranged inside the shock shaft 6 to increase efficiency. extinguish vibrations.

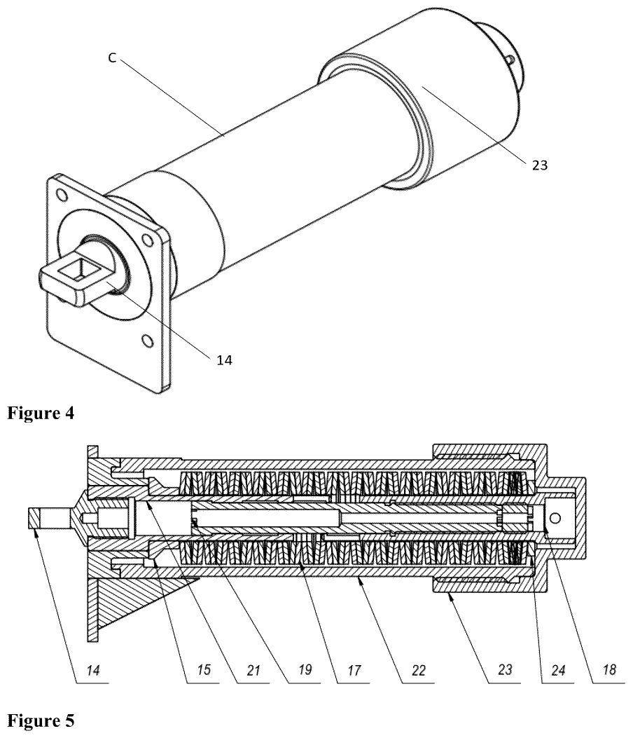

According to a preferred embodiment of the present invention shown in FIG. 1, FIG. 4 and FIG. 5, the longitudinal shock absorber assembly C is structured to include a pulley 14 linked to a transfer cam 25, a first bushing 21 and a pipe. The second liner 18 slides over the centering shaft surface 19 to press the element.

Second elastic 17 absorbs vibrations.

The first bushing 21 is made of a hollow cylindrical structure. One end of the first bushing 21 is connected to the pulling ear 14 in a fixed way with the pulling ear 14 so that when the pulling ear 14 moves, it will pull the first bushing 21 to move as well. As shown in FIGS. 1 and 5, the first bushing 21 and the pulling ear 14 may be connected by a threaded joint with the inner surface of the first bushing 21 being internally threaded and the pulling ear surface 14 having a body cylindrical cylinder externally threaded to mate with the internal thread of the first bushing 21. One of ordinary skill in the art is aware that other methods of connection may be applied, for example tenon joints or riveted, or screwed, provided that rigid connection of the pulling ear 14 with the first bushing 21 is ensured. Such variations are also within the scope of the present invention. The first bushing end 21 that connects to the pulling ear 14 is extended wider than the sliding body to create a sliding bush stopper 15. The other end of the first bushing 21 far from the pulling ear 14 is ridged on the inside of the tube to fit into the lip created on the centering shaft 19. This structure ensures that the first bushing 21 can pull the centering shaft 19 to move in one direction, and the first bushing 21 slides on the surface of the centering shaft 19 in reverse. As shown in FIGS. 1 and 5, when the first bushing 21 moves to the left, the centering shaft 19 moves to the left, and when the first bushing 21 moves to the right, it slides on the surface of the centering shaft 19.

The centering shaft 19 is arranged inside the first bushing 21. One end of the centering shaft 19 is made to match the edge on the inside of the first bushing 21, the other end of the centering shaft 19 is fixed to the inside of the bushing, second bushing 18. The centering shaft 19 and the second bushing 18 can be connected by various types of joints, for example threaded joints or tenon joints, provided that ensure that when the centering shaft 19 moves, the second bushing 18 will move. These various connection schemes can be performed by one of ordinary skill in the art without further description and are within the scope of the invention.

The second bushing 18 is made of a hollow cylindrical structure arranged around the outside of the centering shaft 19 and opposite the first bushing 21. The end of the second bushing 18 which is located far from the first bushing 21 is opened, larger than the pipe body to serve as a flange to block the second elastic element 17. An additional washer 24 may be arranged between the second bushing 18 and the second elastic element 17 as shown in FIGS. 1 and 5. The number of 24 washers can also be increased for convenient adjustment during use.

The second elastic element 17 is arranged externally to the first bushing 21 and the second bushing 18 such that movement of the first bushing 21 and/or second bushing 18 will cause deformation of the elastic element second 17.

Many types of machine parts are known, such as springs, torsion bars, etc. as long as they have the right stiffness and size. According to a preferred embodiment of the invention shown in FIGS. 1 and 5, the second elastic element 17 is a spring arranged coaxially with the centering axis 19, the second bushing first bushing 21, second bushing 18 and surrounding first bushing 21, second bushing 18. Also the second elastic element 17 can be arranged in another way, for example using multiple spring arrangements around the circumference of the cross-section two bushings 21, 18. These arrangement options are also within the scope of the invention.

According to another embodiment not shown in the drawings, the vertical shock absorber assembly C also includes a telescopic damping element arranged inside the centering shaft 19 to increase the effectiveness of vibration suppression.

As shown in FIG. 1, FIG. 4 and FIG. 5, the body of the vertical shock absorber assembly 22 is made of a cylindrical structure that covers the parts of the longitudinal shock absorber assembly C. The body of the vertical shock absorber assembly 22 connects to the main body assembly B so that the vertical shock absorber assembly C is perpendicular to the horizontal shock absorber assembly D. To increase the ability to protect the details, the vertical shock absorber assembly C also includes a stopper 23 arranged to cover the vertical shock absorber assembly C at the end of the second bushing 18. The stopper 23 can be connected to the vertical shock absorber assembly body 22 by many types of joints, for example threaded joints or dovetail joints, provided that the internal space is enclosed. Cluster longitudinal shock absorber C. These various connection schemes can be made by one of ordinary skill in the art without further description and are within the scope of the invention.

Horizontal shock absorber assembly D is linked to vertical shock absorber assembly C through the transfer cam 25. The transfer cam 25 is constructed with one end linked in a rotatable manner with the slide shaft 8 of the horizontal shock absorber assembly D and one end is linked in a rotatable manner with the pulling arm 14 of the longitudinal shock absorber assembly C. The transfer cam 25 can rotate around the cam axis 20 arranged perpendicular to both the horizontal shock absorber assembly D and Vertical shock absorber assembly C. According to a preferred embodiment of the invention shown in FIG. 1, the transfer cam 25 is connected to the pulley 14 of the longitudinal shock absorber assembly C through a ball joint. Other connection mechanisms can also be used, for example hinge joints. These layout options are also within the scope of the invention.

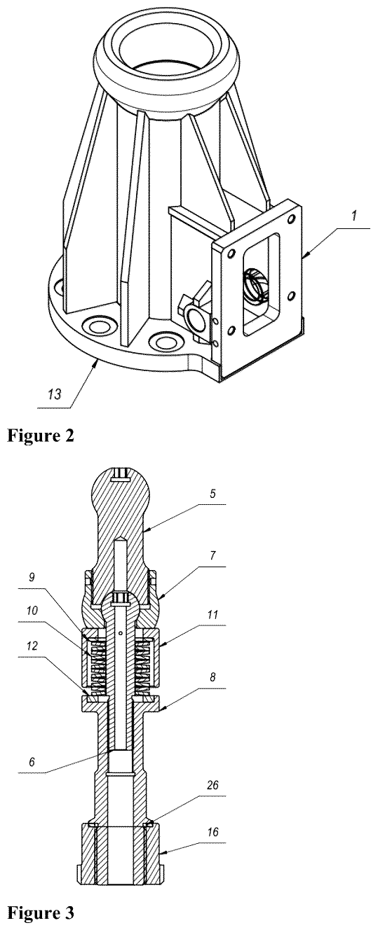

Main body assembly B to connect horizontal shock absorber assembly D and vertical shock absorber assembly C. As shown in FIGS. 1 and 2, main body assembly B is created with a hollow cylindrical structure to accommodate sliding shaft 8 of the horizontal shock absorber assembly. Create a gap on the cylindrical body to accommodate the shifting cam 25. The first flange 1 is created at the above clearance to connect with the longitudinal shock absorber assembly body 22.

The first flange 1 can be connected to the longitudinal shock absorber assembly body 22 by many types of joints, for example such as a bolted joint as shown in FIG. 2 or a dovetail joint, provided that a tight connection of the longitudinal shock absorber assembly C to the main body assembly B is ensured. These various connection options can be used by a competent person of ordinary skill in the art without further description and are within the scope of the present invention.

However, the preferred option is bolted joints to ensure rigidity and also facilitate disassembly and maintenance. Main body assembly B also includes a second flange 13 located at the bottom of main body assembly B to connect with stand D. This connection also prefers the use of bolted joints, but other types of joints can also be applied. In a preferred embodiment, main body assembly B preferably also includes stiffening ribs to increase structural rigidity while also assisting in heat dissipation.

Operating principle of shock absorber mechanism G according to the invention:

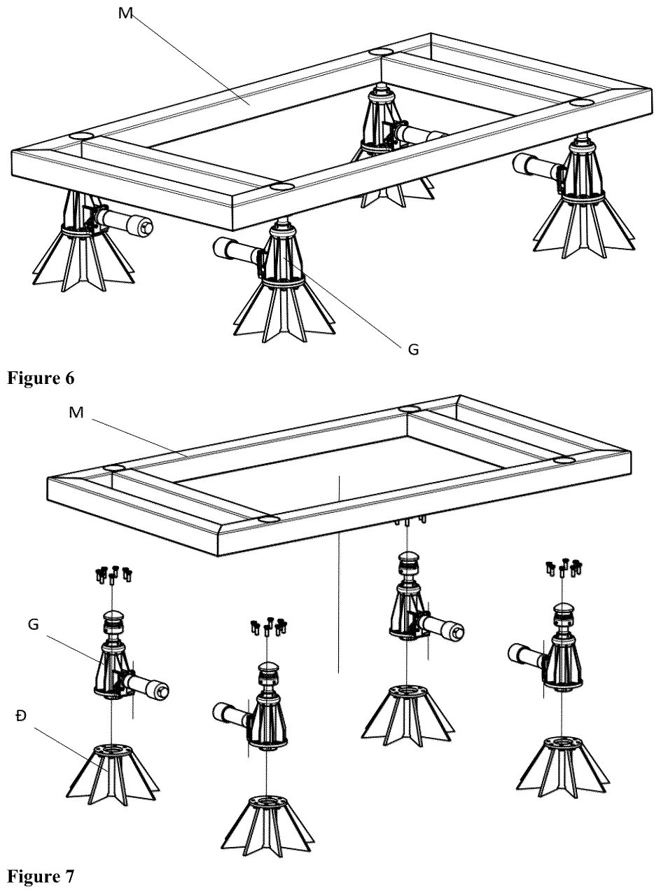

According to an example embodiment of the present invention shown in FIGS. 6 and 7, apparatus work is placed on the M frame connecting four G shock absorber mechanisms, each G shock absorber is placed on a stand to ensure stability. The load causing vibration from the working equipment will be transmitted through frame M to each shock absorber G.

Shock absorber assembly G receives the load causing vibration of the equipment at bridge deck pillar A. Regardless of which direction this load acts, it can be decomposed into two components, one acting in the vertical direction causing vertical vibration and one acting in the horizontal direction causing horizontal oscillation.

For the load component acting in the horizontal direction, regardless of the direction of this load, it also creates a rotation effect on bridge deck A. Bridge deck A, support post 5, adjusting nut 7, swing shaft 6 moves together. When the deck cylinder A rotates, the spring shaft 6 also rotates and is screwed to the sliding shaft 8. The adjusting nut 7 also rotates and compresses the cap 11. The cap 11 presses the first elastic element 10. Elastic element first 10 will be elastic to absorb vibrations.

For the load component acting in the vertical direction, if the load has an impact direction from top to bottom, bridge deck pillar A will be pushed down, causing the swing shaft 6 and sliding shaft 8 to slide vertically inside the body assembly. B. When the slide shaft 8 goes down, the transfer cam 25 will rotate counterclockwise as seen in FIG. 1 and pull the pulley 14 to the left. The first bushing 21 fixed to the pulling ear 14 also moves to the left pulling the centering shaft 19 to the left. The centering shaft 19 is fixed to the second bushing 18 so when the centering shaft 19 moves to the left will pull the second bushing 18 to the left forcing the second elastic element 17 to compress to the left to absorb vibrations.

If the vertical load acts from bottom to top, spring shaft 6 and sliding shaft 8 will be pushed upward. When slider 8 moves up, cam 25 will rotate clockwise as seen in FIG. 1 and push pulley 14 to the right. Then, the first bushing 21 slides on the outer surface of the centering shaft 19 to the right. When the first bushing 21 moves to the right, the sliding bearing 15 moves to the right, pushing the second elastic element 17 to compress to the right to absorb vibrations.

### Possible Benefits

The shock absorber assembly uses two push spring assemblies used to reduce overloading of the equipment. In particular, the shock absorber structure proposed by the authors absorbs the overload of 5 degrees of freedom of the device bag.

Shock absorbers can be used in harsh, high reliability, impact environments fast. Thanks to the purely mechanical use, the maintenance and repair process is easy.

Above, the invention has been described through priority options. People with average knowledge of the respective technical field can make various variations as long as they do not fall outside the scope of protection below.

1. Shock absorber mechanism, including:
at least one horizontal shock absorber assembly to absorb horizontal vibrations, the horizontal shock absorber assembly is structured to include a bridge deck pier to receive a load causing vibrations, and a shock shaft linked to the bridge deck pier in a rotating manner, together with the bridge deck and linked to a slide shaft in a rotatable manner inside the slide shaft, a first elastic element is arranged around a swing shaft so that when the swing shaft rotates, it will cause deformation of the first elastic element, the slide shaft is arranged around the swing shaft and is structured so that it can slide inside a main body assembly, on the sliding shaft body there is a part connected to a transfer cam;
at least one vertical shock absorber assembly to absorb vibrations in a vertical direction, the vertical shock absorber assembly being structured to include a pulley connected to the transfer cam, a first bushing having one end connected to the pulley in a fixed way, fixed with a pulling ear, an other end of the first bushing has an inner surface is made to match an edge created on a centering shaft, the centering shaft is arranged inside the first bushing, one end of the centering shaft is made to match an edge on the inside of the first bushing so that the first bushing can pull the centering shaft to move in one direction and the first bushing slides on a surface of the centering shaft in an opposite direction, an other end of the centering shaft is fixed to an inside of a second bushing, the second bushing is arranged outside the centering shaft and opposite the first bushing, a second elastic element is arranged outside the second bushing, first bushing and the second bushing such that when the first bushing and/or the second bushing move, it will cause deformation of the second elastic element, the body of the longitudinal shock absorber assembly is made of a cylindrical structure covering parts of the vertical shock absorber assembly, the vertical shock absorber assembly body connects to the main body assembly so that the vertical shock absorber assembly is perpendicular to the horizontal shock absorber assembly;
in which the horizontal shock absorber assembly is linked to the vertical shock absorber assembly through a transfer cam, the transfer cam is structured with one end linked in a rotatable manner with a sliding axis of the horizontal shock absorber assembly and one end connected in a rotatable manner, with the pulling ear of the vertical shock absorber assembly, the cam can rotate around a cam axis arranged perpendicular to both the horizontal shock absorber assembly and the vertical shock absorber assembly;
at least one main body assembly to connect the horizontal shock absorber assembly and the vertical shock absorber assembly, the main body assembly is created with a hollow cylindrical structure to accommodate the sliding axis of the horizontal shock absorber assembly, a gap is created on the cylindrical body to accommodate the shifting cam, the first flange is created at the above clearance to connect with the body of the vertical shock absorber assembly.

2. The shock absorber mechanism according to claim 1, in which the horizontal shock absorber assembly also includes a support pillar connecting a bridge deck pillar with the suspension shaft, a cover arranged around and covering a top of the first elastic element, and a control nut. adjust an outer part of the connection between the support column and the swing shaft, the adjusting nut is located above the above cover.

3. The shock absorber mechanism according to claim 2, in which the bridge deck pillar includes a top with a spherical cap structure and a locking cover to connect the bridge deck pillar with the support pillar.

4. The shock absorber mechanism according to claim 1, in which the cam is connected to the horizontal shock absorber assembly and vertical shock absorber assembly through a ball joint.

5. The shock absorber mechanism according to claim 1, in which the main body assembly also includes a second flange arranged at a bottom of the main body assembly to connect with the base, and a travel stop cover arranged at the bottom of the main body assembly to connect with the base, hollow bottom of main body assembly to limit movement position of the sliding shaft inside the main body assembly.

6. The shock absorber mechanism according to claim 1, wherein the main body assembly further includes stiffening ribs.

7. A shock absorber mechanism according to claim 1, wherein the first elastic element and the second elastic element are springs.

8. The shock absorber mechanism according to claim 1, wherein the horizontal shock absorber assembly also includes a telescopic damping element arranged inside the shock shaft.

9. The shock absorber mechanism according to claim 1, wherein the longitudinal shock absorber assembly further includes a telescopic damping element arranged within the centering shaft.
